(19) United States
(12) Patent Application Publication
(10) Pub. No.: US 2026/0367246 A1
(43) Pub. Date: Nov. 19, 2026

(54) AUDIO-WAVE ASSISTED RADIO WAVE POSITIONING

(71) Applicant: QUALCOMM Incorporated, San Diego, CA (US)

(72) Inventors: Yuxiang PENG, San Jose, CA (US); Jason FILOS, Newark, NJ (US); Ning LUO, Cupertino, CA (US)

(21) Appl. No.: 19/135,324

(22) PCT Filed: Dec. 6, 2023
(86) PCT No.: PCT/US2023/082733

§ 371 Date: Jun. 3, 2025

(30) Foreign Application Priority Data
Jan. 19, 2023 (GR) 20230100037

(51) Int. Cl. G01S 15/06; G01S 7/539; G01S 15/86; H04B 7/195; H04L 5/00

(52) U.S. Cl. CPC G01S 15/06; G01S 7/539; G01S 15/86; H04B 7/195; H04L 5/0051

(57) ABSTRACT

A user equipment (UE) may receive an audio wave (AW) echo. The AW echo may include an echo of at least one previous AW. The UE may calculate an echo profile based on the received AW echo. The UE may receive the AW echo via a microphone. The UE may perform acoustic context detection (ACD) to calculate acoustic scene parameters based on the echo profile. The UE may select an operation mode from a set of operation modes of a positioning engine (PE) based on the calculated acoustic scene parameters. The UE may receive a positioning reference signal (PRS) from a network node. The UE may receive the PRS via a transceiver. The UE may calculate a position of the UE using the PE based on the PRS and the operation mode selected in accordance with the calculated acoustic scene parameters of the echo profile.

### CROSS-REFERENCE TO RELATED APPLICATION

This application claims the benefit of Greece Patent Application Serial No. 20230100037, entitled “AUDIO-WAVE ASSISTED RADIO WAVE POSITIONING” and filed on Jan. 19, 2023, which is expressly incorporated by reference herein in its entirety.

### TECHNICAL FIELD

The present disclosure relates generally to communication systems, and more particularly, to a radio frequency (RF) positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive an audio wave (AW) echo. The AW echo may include an echo of at least one previous AW. The apparatus may calculate an echo profile based on the received AW echo. The apparatus may perform positioning based on the echo profile. For example, the apparatus may calculate a position of the UE based on the echo profile.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of UE positioning based on reference signal measurements.

FIG. 5A is a diagram illustrating an example of a UE configured to calculate an echo profile based on a received audio wave (AW) echo.

FIG. 5B is a diagram illustrating an example of a UE configured to calculate another echo profile based on a received AW echo.

FIG. 5C is a diagram illustrating an example of a UE configured to calculate another echo profile based on a received AW echo.

FIG. 6 is a diagram illustrating an example of a UE configured to calculate a position of the UE based on an echo profile.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors, individually or in any combination, in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

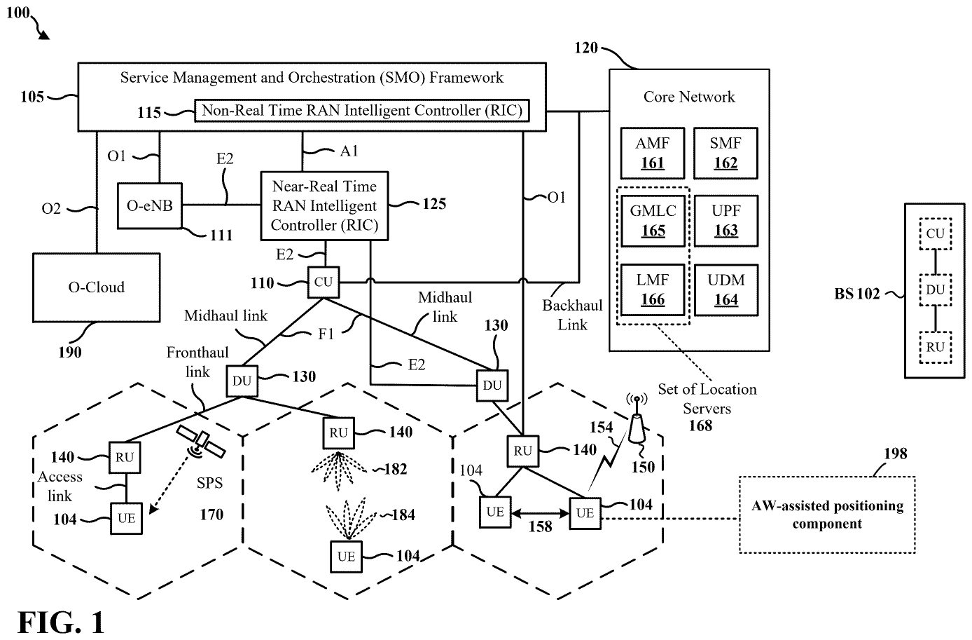

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor(s) or controller(s), individually or in any combination, providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. As used herein, a device configured to estimate a set of values may calculate the set of values based on a set of input values. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an AW-assisted positioning component 198 that may be configured to receive an audio wave (AW) echo. The AW echo may include an echo of at least one previous AW. The AW-assisted positioning component 198 may be configured to calculate an echo profile based on the received AW echo. The AW-assisted positioning component 198 may be configured to calculate an echo profile based on the received AW echo. In other words, the UE 104 may be configured to utilize an AW echo to contextualize an environment about the UE, such as how many obstacles are about the UE or whether a line-of-sight (LOS) path to a TRP of a base station is blocked. The UE 104 may then adjust how it performs positioning based on the contextualized environment variables. For example, the UE 104 may contextualize an environment about the UE 104 to determine what blocking objects may be about the UE 104 to determine a reflection path between the UE 104 and another wireless device if the LOS path directly between the UE 104 and the wireless device is blocked.

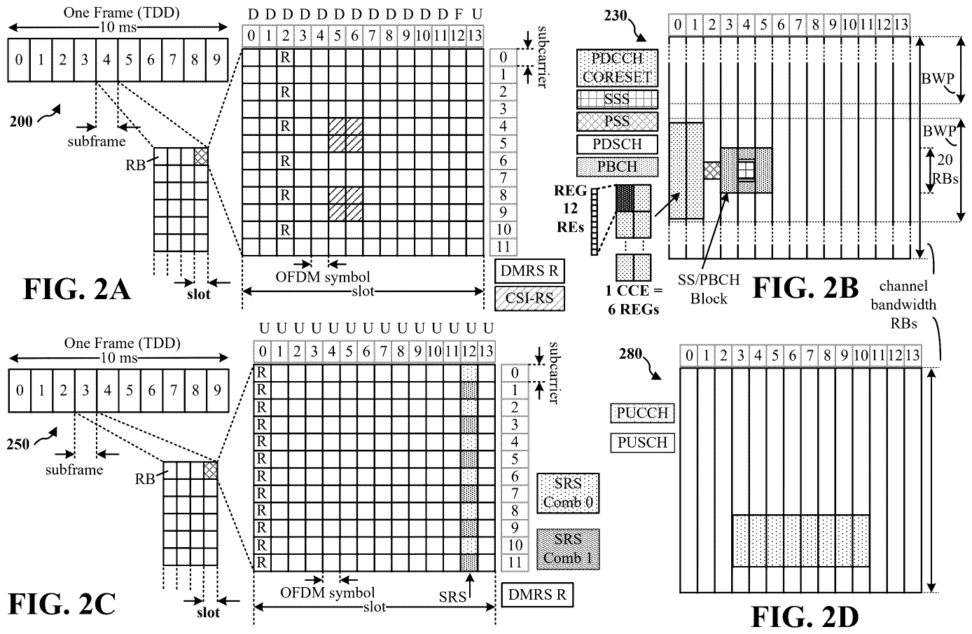

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

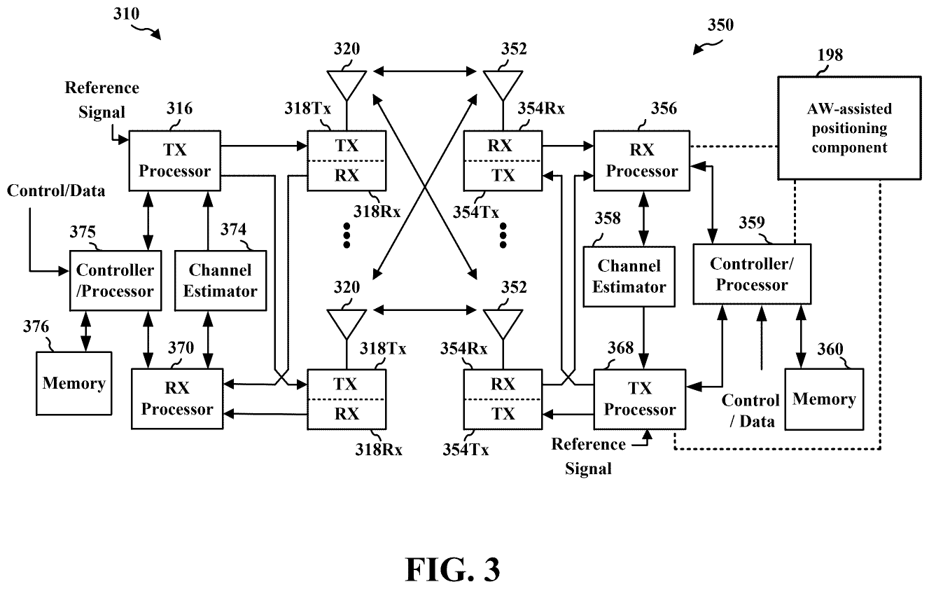

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the AW-assisted positioning component 198 of FIG. 1.

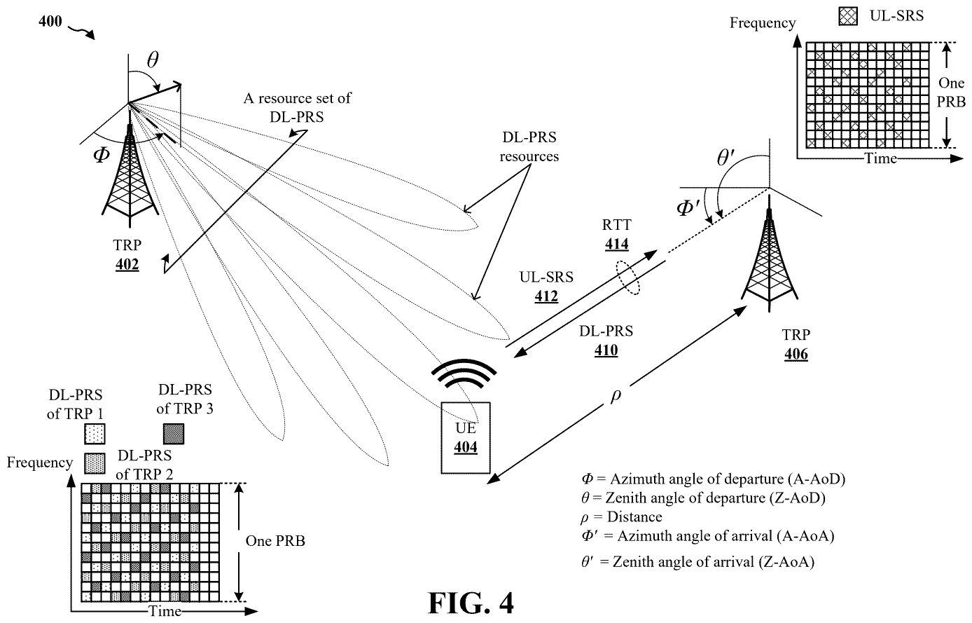

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}-T_{PRS_TX}|-|T_{SRS_TX}-T_{PRS_RX}|. Accordingly, multi-RTT positioning may make use of the UE Rx-Tx time difference measurements (i.e., |T_{SRS_TX}-T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

The UE 404 may have a positioning engine (PE) configured to perform positioning on RSs received by the UE 404 based on an operation mode of the PE. The operation mode may change based upon contextual environmental properties about the UE 404. For example, the PE may have a free field operation mode for environments with very few obstacles that block or reflect RF signals, a suburban operation mode for environments with many obstacles that block or reflect RF signals, an indoor operation mode for environments with close obstacles that block or reflect RF signals, or a deep urban operation mode for environments that have many obstacles that block or reflect RF signals and many interfering devices that introduce noise to the RF environment about the UE 404. The PE may use a different time update model for performing a GNSS fix based on the operation mode. The PE may use a different noise uncertainty R model in a Kalman filter based on the operation mode. In one aspect, a PE using a free field operation mode may have a lower R (e.g., 1) than a PE using a deep urban operation mode (e.g., 10). In some aspects, a user of the UE 404 may set the operation mode of its PE via a user interface of the UE 404. In other aspects, the UE 404 may be configured to change an operation mode of its PE based on a calculated position or location of the UE 404. For example, the UE 404 may change its operation mode based upon a GNSS fix result (e.g., a deep urban operation mode if it is in New York, NY, and a suburban operation mode if it is in El Paso, TX). However, the UE 404 may not be able to detect whether it is in a building or may wish to use a free field operation mode if it is in an open space area of an urban city, such as a large park.

In some aspects, a UE may be configured to use acoustic waves (AWs) to perform sound source localization and to sense one or more acoustic scene parameters of an acoustic scene about the UE. An acoustic wave may be any audio wave that may be detected by an audio sensor of the UE, such as a set of microphones. The UE may transmit an AW, for example via one or more speakers of the UE, and may measure one or more properties of a received AW, such as a dB level of the AW, or a reverberation decay of the AW. An AW may reflect off of one or more obstacles, such as a wall of a building, or a vehicle, causing an AW echo to reflect off of the obstacle.

A portion of a signature of an AW echo of an AW may be the same as a portion of a signature of the AW that originated the AW echo. For example, an AW transmitted by a UE may increase in pitch and decrease in pitch at a given rate, and the AW echo of that same AW which is received by the UE may also increase in pitch and decrease in pitch at the same rate. The UE may generate a signature for an emitted AW. The signature of the emitted AW may include a set of acoustic characteristics, such as a pitch of the emitted AW, a frequency of the emitted AW, or a loudness (e.g., dB level) of the emitted AW over a time period. An echo of the emitted AW received by the UE at a later time period may share a pitch, but may have a smaller loudness (e.g., lower by a few dBs), and may have a different frequency. Such changes to the echo AW compared to the emitted AW may be based on an absorption coefficient of the material in the reflecting object. The UE may recognize a same pitch of an AW echo over time as one matching the same pitch of an emitted AW over time, and may calculate the absorption coefficient of the material of the reflection object based on the differences of the frequency and/or the differences of the loudness of the emitted AW as compared with the AW echo. In other aspects, a plurality of AW echoes may be generated from a single emitted AW, for example if the UE is in an enclosed room and multiple walls reflect the emitted AW. The UE may be configured to analyze the plurality of AW echoes to determine how many objects are reflecting the AW echoes, and may also determine if an AW echo is a first-order echo (i.e., direct reflection from the emitted AW), a second-order echo (i.e., a reflection of a reflected echo of the emitted AW), or a higher-order echo. The UE may be configured to track the envelope of the reflections to calculate one or more reverberation characteristics, for example absorption coefficients of objects that reflect sounds and distances between objects that reflect sounds. In some embodiments, the UE may generate a relative position map between objects that reflect sounds based on the AW echo, for example the distance between a first object that reflects an emitted AW and a second object that reflects the emitted AW, in addition to the distance between the UE and each of the first and second objects.

A speaker of a UE may be configured to transmit an AW in a frequency band that is in a range beyond what a human ear may detect. For example, a UE may be configured to detect an AW frequency band between 20 Hz to 23 kHz, while a human next to the UE may hear sounds in a frequency range between 20 Hz to 20 kHz. As such, the UE may transmit AW sounds in the frequency band between 20 kHz to 23 kHz without impacting a human next to the UE. The environment sensing capability of such a UE (e.g., smartphone, automotive UE, internet-of-things (IoT) UE) may be commercially ready for mass-market devices. The UE may transmit one or more AWs, and perform acoustic context detection (ACD) on a set of sounds received by the UE, for example a set of received AW echoes, or a set of environmental sounds (e.g., car horns, pedestrians talking, etc.) to infer a context of an acoustic scene using feature matching or machine learning (ML) based techniques. In one aspect, a UE may be configured to perform ACD techniques on a set of AWs to detect sound events and segment (e.g., perform diarization) for a polyphonic system output approach. The UE may recognize AW echoes of AWs transmitted by the UE and reflected off of surfaces, or may recognize AWs generated by objects about the UE, such as engine noises from a car vehicle, engine noises from a bus vehicle, footsteps from a person, or speech from a human or a speaker.

In one aspect, a set of AW echoes may indicate the presence of an object that reflects a set of AWs transmitted by the UE. In another example, a UE may receive a set of environmental sounds, and may match at least a portion of the environmental sounds with objects that match an acoustic scene, such as car horns in a deep urban acoustic scene or people talking and echoes from the people talking in an indoor scene. In some aspects, a UE may be configured to associate a sound of car horns with an urban environment. A higher number of car horns detected within a time period may be associated with a deep urban environment and a lower number of car horns detected within a time period may be associated with a suburban environment. In some aspects, a UE may be configured to associate a sound of birds chirping with a free field environment, or a park environment. The UE may then use such contextual information to alter how it performs positioning, for example by selecting an operation mode for its PE. In another aspect, the UE may estimate a carrier-to-noise ratio based on one or more measured acoustic scene parameters. The UE may perform a low-earth-orbit (LEO) positioning based on a carrier-to-noise ratio, or may perform a non-terrestrial network (NTN) communication with a base station based on a carrier-to-noise ratio. In other words, the UE may use AW to sense the local acoustic scene about the UE for RF-based positioning purposes.

A UE may receive an AW echo. The AW echo may include an echo of at least one previous AW. The UE may calculate an echo profile based on the received AW echo. The UE may receive the AW echo via a set of microphones. The UE may perform ACD to estimate acoustic scene parameters based on the echo profile. The UE may select an operation mode from a set of operation modes of a PE based on the estimated acoustic scene parameters. The UE may receive a PRS from a network node. The UE may receive the PRS via a transceiver. The UE may calculate a position of the UE using the PE based on the PRS and the operation mode selected in accordance with the estimated acoustic scene parameters of the echo profile.

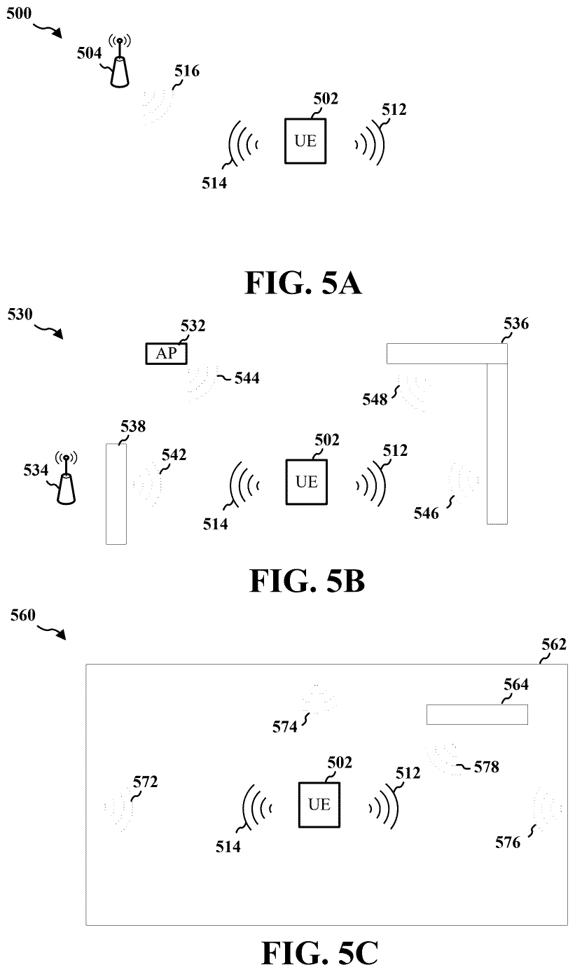

FIG. 5A is a diagram 500 illustrating an example of a UE 502 configured to calculate an echo profile of an acoustic scene about the UE 502 based on the AW echo 516. The UE 502 may be configured to directionally transmit one or more AWs, such as the AW 512 in one direction and the AW 514 in another direction. For example, the UE 502 may have a first speaker that faces one direction and a second speaker that faces another direction, and the UE 502 may use the first speaker to transmit the AW 512 and the second speaker to transmit the AW 514. The AW 514 may reflect off of the base station 504 as the AW echo 516. The UE 502 may receive the AW echo 516 via one or more sensors of the UE 502, for example a microphone of the UE 502. The UE 502 may have a plurality of microphones, enabling the UE 502 to perform directional sensing of AW echoes received by the UE 502. The UE 502 may be equipped with a set of stereophonic (directional) or compact microphone arrays or speaker arrays. The UE 502 may include a smartphone or an internet of things (IoT) autonomous system, such a robot. The UE 502 may perform ACD on the AW echo 516 to determine that the UE 502 is in a free field acoustic scene, where there are few obstacles between the UE 502 and the base station 504. The UE 502 may perform positioning using an open field operation mode with the base station 504.

FIG. 5B is a diagram 530 illustrating an example of a UE 502 configured to calculate an echo profile of an acoustic scene about the UE 502 based on the AW echo 542, the AW echo 544, the AW echo 546, and/or the AW echo 548. The UE 502 may be configured to directionally transmit one or more AWs, such as the AW 512 in one direction and the AW 514 in another direction. The AW 514 may reflect off of the obstacle 538 as the AW echo 542. The AW 514 may reflect off of the AP 532 as the AW echo 544. The AW 512 may reflect off of the obstacle 536 as the AW echo 546. The AW 512 may reflect off of the obstacle 536 as the AW echo 548. The UE 502 may receive the AW echo 542, the AW echo 544, the AW echo 546, and/or the AW echo 548 via one or more sensors of the UE 502, for example one or more microphones of the UE 502. The UE 502 may perform ACD on the AW echo 542, the AW echo 544, the AW echo 546, and/or the AW echo 548 to determine that the UE 502 is in a suburban acoustic scene, where there are many obstacles about the UE 502. The UE 502 may perform a non-line-of-sight (NLOS) detection with the base station 534. The UE 502 may determine that there is an obstacle 538 located between the UE 502 and the base station 534, which presents a non-line-of-sight (NLOS) between the UE 502 and the base station 534. In response, the UE 502 may configure a connection path with the base station 534, for example via the AP 532. The UE 502 may perform positioning using a suburban operation mode with the base station 534 via the AP 532.

FIG. 5C is a diagram 560 illustrating an example of a UE 502 configured to calculate an echo profile of an acoustic scene about the UE 502 based on the AW echo 572, the AW echo 574, the AW echo 576, and/or the AW echo 578. The UE 502 may be within a room 562. The UE 502 may be configured to directionally transmit one or more AWs, such as the AW 512 in one direction and the AW 514 in another direction. The AW 514 may reflect off of a wall of the room 562 as the AW echo 572. The AW 514 and/or the AW 512 may reflect off of a wall of the room 562 as the AW echo 574. The AW 512 may reflect off of a wall of the room 562 as the AW echo 576. The AW 512 may reflect off of the obstacle 564 of the room 562 as the AW echo 578. The UE 502 may receive the AW echo 572, the AW echo 574, the AW echo 576, and/or the AW echo 578 via one or more sensors of the UE 502, for example one or more microphones of the UE 502. The UE 502 may perform ACD on the AW echo 572, the AW echo 574, the AW echo 576, and/or the AW echo 578 to determine that the UE 502 is in an indoor acoustic scene. In response, the UE 502 may perform positioning using an indoor operation mode.

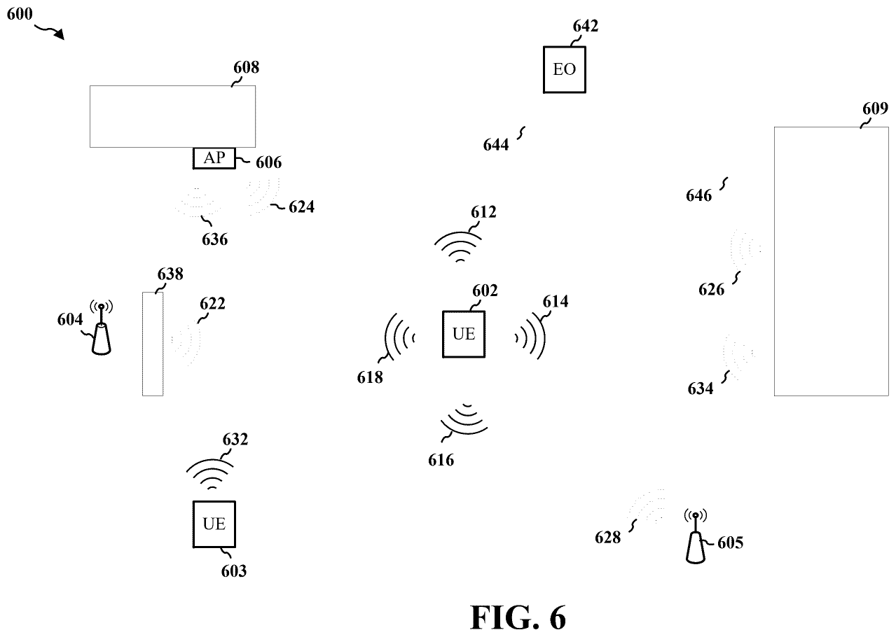

FIG. 6 is a diagram 600 illustrating an example of a UE 602 configured to calculate a position of the UE 602 based on an echo profile of an acoustic scene about the UE 602 based on the AW echo 622, the AW echo 624, the AW echo 626, the AW echo 628, the AW echo 634, the AW echo 636, the AW 644, and/or the AW echo 646. The UE 602 may be within a deep urban environment. The UE 602 may be configured to directionally transmit one or more AWs, such as the AW 612 in a first direction, the AW 614 in a second direction, the AW 616 in a third direction, and the AW 618 in a fourth direction. The AW 618 may reflect off of an object 638 as the AW echo 622. The AW 618 and/or the AW 612 may reflect off of an obstacle 608, which the AP 606 is mounted to, as the AW echo 624. The AW 614 may reflect off of an obstacle 609 as the AW echo 626. The AW 614 and/or the AW 616 may reflect off of the base station 605 as the AW echo 628. The UE 603 may also transmit an AW 632. The UE 602 may know the acoustic signature of the AW 632 by receiving a sidelink transmission from the UE 603, or by receiving a configuration of AW signatures from a serving cell of the UE 602. The AW 632 may reflect off of the obstacle 608 as the AW echo 636. The AW 632 may reflect off of the obstacle 609 as the AW echo 634. The environmental object 642 may be an object, such as a car or a person, that generates sounds, such as the AW 644. The AW 644 may not originate from any UE device. The AW 644 may reflect off of the obstacle 609 as the AW echo 646.

The UE 602 may receive the AW echo 622, the AW echo 624, the AW echo 626, the AW echo 628, the AW echo 634, the AW echo 636, the AW 644, and/or the AW echo 646 via one or more sensors of the UE 602, for example one or more microphones of the UE 602. The UE 602 may perform ACD on the AW echo 622, the AW echo 624, the AW echo 626, the AW echo 628, the AW echo 634, the AW echo 636, the AW 644, and/or the AW echo 646 to determine that the UE 602 is in a deep urban acoustic scene. The UE 602 may recognize that the AW 644 has a signature that does not match a signature of any of the AWs transmitted by a UE known to the UE 602, such as the AW 612, the AW 614, the AW 616, or the AW 618 originating from the UE 602 or the AW 632 originating from the UE 603. The UE 602 may register the AW 644 as an environmental sound, and may analyze the AW 644 to match it against recognized sounds, such as an urban object (e.g., vehicle engines, vehicle horns, bells, people) or a rural object (e.g., birds, wind, crunching leaves), or an indoor object (e.g., doors opening or closing, local area network (LAN) phones ringing). The UE 602 may recognize the AW echo 646 as an echo of the AW 644 by matching at least a portion of the signature of the AW 644 with the AW echo 646. The UE 602 may differentiate a suburban scene from a deep urban scene by a threshold number of urban objects detected (e.g., equal to or below the threshold number may be associated with a suburban scene, equal to or above the threshold number may be associated with an urban scene). The UE 602 may perform NLOS detection with the base station 604 to determine that there is an object 638 between the UE 602 and the base station 604. In response, the UE 602 may perform positioning using a deep urban operation mode with the base station 605 and/or the base station 604 via the AP 606 or the UE 603 as a relay. The base station 604 may include a TRP. The base station 605 may include a TRP.

In some aspects, the UE 602 may perform NLOS detection by operating in an RF driven mode. The UE 602 may transmit AW in directions where known wireless devices (e.g., RF beacons and/or receivers) are located, for example known locations of TRPs or known locations of fixed UEs. In response to the UE 602 transmitting an AW in a direction of a known wireless device and subsequently receiving an AW echo from the same direction, the UE 602 may prorogate an RF signal through an NLOS path. In other aspects, the UE 602 may perform NLOS detection by operating in an all sky scanning mode. The UE 602 may transmit AW in all directions in space using time sequences, similar to radar detection of nearby objects. In response to the UE 602 detecting an object in a transmitted direction via a set of received AW echoes, the UE 602 may label RF signals from that direction as NLOS signals. The all sky canning mode may consume more power than the RF driven mode, but may save more power in the long run, as the UE 602 may use a set of directional RF antennas that use signal blanking in the NLOS directions. In response to detecting a blocking object in a direction (e.g., a direction where NLOS signals exist), the UE 602 may discard measurements of RF signals received from that direction, or may reduce the weight of RF signals received from that direction. In some aspects, if the UE 602 detects a multipath signal from a NLOS direction, the UE 602 may be configured to allocate UE communication links with another direction's RF beacons with a lower echo level. The echo level may be measured in dB. Such a configuration may improve both positioning and communication quality.

The UE 602 may analyze echo data, such as from the AW echo 624 and the AW echo 622, as a function of the AW 618 transmitted by the UE 602 in four dimensions—three dimensions as a spatial directional output and one more dimension as a temporal time period when the AW 618 is transmitted and its echoes are received. The UE 602 may be configured to infer that an obstacle in the direction an AW is emitted is likely causing an AW echo received by the UE 602 when an echo level of the AW echo is equal to or above a certain threshold when the AW is transmitted in that direction. The UE 602 may analyze the AW echo to determine one or more absorption characteristics of the object reflecting the AW echo. For example, the UE 602 may determine if the object is made of metal, a perforated material, or a brick material, as different objects have different associated absorption coefficients. Certain objects may be associated with different RF wave propagation coefficients as well, for example a metal object may reflect an RF wave while a brick material may block an RF wave. The UE 602 may calculate geometry of a reflective object, for example rectangular geometry inferred by reflections off of a plurality of walls about a room having absorption coefficients associated with wall materials. The UE 602 may calculate a volume of a room from a reverb level of a set of AW echoes. The UE 602 may calculate obstacle sizes and locations with respect to the UE 602 based on a set of AW echoes.

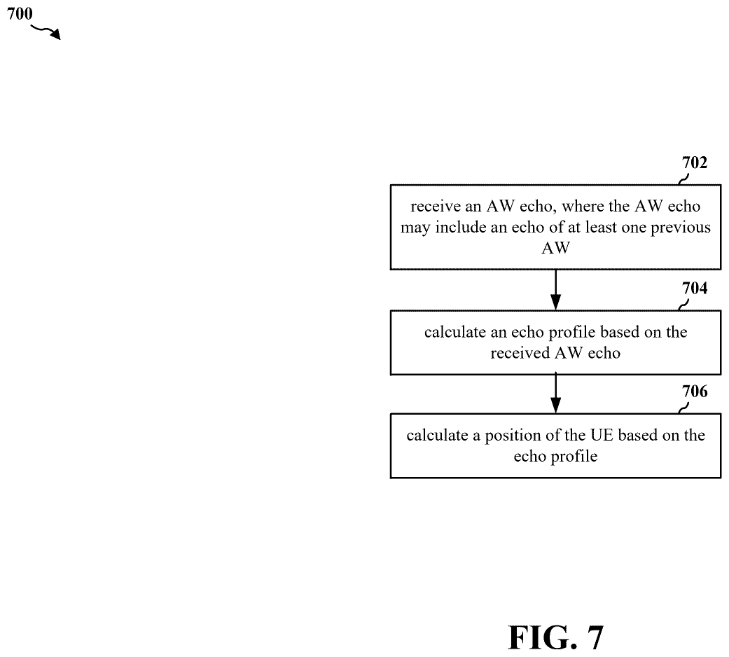

FIG. 7 is a flowchart 700 of a method of wireless communication. The method may be performed by a UE (e.g., the UE 104, the UE 350, the UE 404, the UE 502, the UE 602; the apparatus 1104). At 702, the UE may receive an AW echo. The AW echo may include an echo of at least one previous AW. For example, 702 may be performed by the UE 602 in FIG. 6, which may receive the AW echo 622, the AW echo 624, the AW echo 626, the AW echo 628, the AW echo 634, the AW echo 636, and/or the AW echo 646. The AW echoes may include an echo of a previous AW. For example, the AW echo 622 may be an echo of the AW 618. The AW echo 624 may be an echo of the AW 618. The AW echo 626 may be an echo of the AW 614. The AW echo 628 may be an echo of the AW 616. The AW echo 634 may be an echo of the AW 632. The AW echo 636 may be an echo of the AW 632. The AW echo 646 may be an echo of the AW 644. 702 may also be performed by the component 198 in FIG. 1, 3, or 11.

At 704, the UE may calculate an echo profile based on the received AW echo. For example, 704 may be performed by the UE 602 in FIG. 6, which may calculate an echo profile, such as a deep urban echo profile, based on the AW echo 622, the AW echo 624, the AW echo 626, the AW echo 628, the AW echo 634, the AW echo 636, and/or the AW echo 646. 704 may also be performed by the component 198 in FIG. 1, 3, or 11.

At 706, the UE may calculate a position of the UE based on the echo profile. For example, 706 may be performed by the UE 602 in FIG. 6, which may calculate a position of the UE 602 based on the echo profile by using an operation mode, such as a deep urban operation mode, to alter how the UE 602 performs positioning. 706 may also be performed by the component 198 in FIG. 1, 3, or 11.

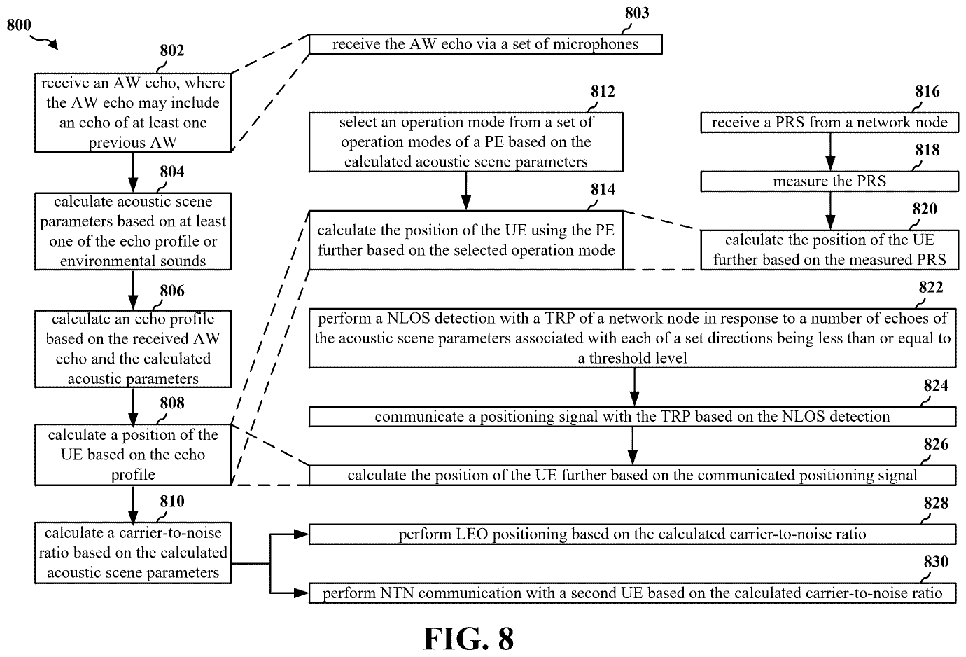

FIG. 8 is a flowchart 800 of a method of wireless communication. The method may be performed by a UE (e.g., the UE 104, the UE 350, the UE 404, the UE 502, the UE 602; the apparatus 1104). At 802, the UE may receive an AW echo. The AW echo may include an echo of at least one previous AW. For example, 802 may be performed by the UE 602 in FIG. 6, which may receive the AW echo 622, the AW echo 624, the AW echo 626, the AW echo 628, the AW echo 634, the AW echo 636, and/or the AW echo 646. The AW echoes may include an echo of a previous AW. For example, the AW echo 622 may be an echo of the AW 618. The AW echo 624 may be an echo of the AW 618. The AW echo 626 may be an echo of the AW 614. The AW echo 628 may be an echo of the AW 616. The AW echo 634 may be an echo of the AW 632.

The AW echo 636 may be an echo of the AW 632. The AW echo 646 may be an echo of the AW 644. 802 may also be performed by the component 198 in FIG. 1, 3, or 11.

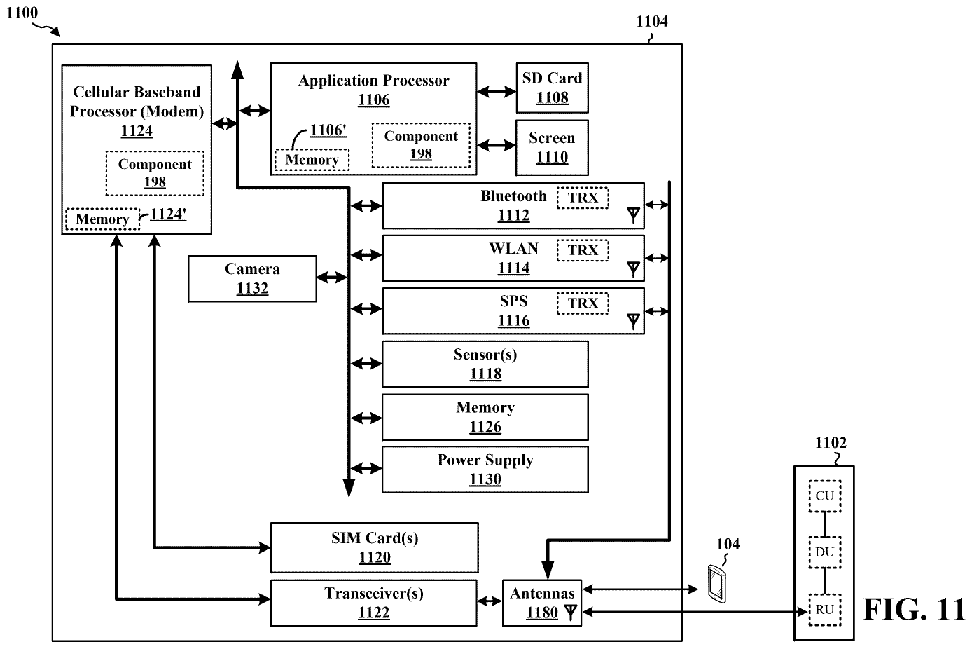

At 803, the UE may receive the AW echo via a set of microphones. For example, 830 may be performed by the UE 602 in FIG. 6, which may receive the AW echo 622, the AW echo 624, the AW echo 626, the AW echo 628, the AW echo 634, the AW echo 636, and/or the AW echo 646 via a set of microphones. A microphone may be included in a UE, such as the apparatus 1104 in FIG. 11 having one of the sensor modules 1118, which may include one or more microphones. 830 may also be performed by the component 198 in FIG. 1, 3, or 11.

At 804, the UE may calculate an echo profile based on the received AW echo. For example, 804 may be performed by the UE 602 in FIG. 6, which may calculate an echo profile, such as a deep urban echo profile, based on the AW echo 622, the AW echo 624, the AW echo 626, the AW echo 628, the AW echo 634, the AW echo 636, and/or the AW echo 646. 804 may also be performed by the component 198 in FIG. 1, 3, or 11.

At 806, the UE may calculate a position of the UE based on the echo profile. For example, 806 may be performed by the UE 602 in FIG. 6, which may calculate a position of the UE 602 based on the echo profile by using an operation mode, such as a deep urban operation mode, to alter how the UE 602 performs positioning. 806 may also be performed by the component 198 in FIG. 1, 3, or 11.

At 808, the UE may calculate a position of the UE based on the echo profile. For example, 808 may be performed by the UE 602 in FIG. 6, which may calculate a position of the UE 602 based on the echo profile, for example by executing a PE in a free field operation mode or a deep urban operation mode based upon attributes of the echo profile. 808 may also be performed by the component 198 in FIG. 1, 3, or 11.

At 810, the UE may calculate a carrier-to-noise ratio based on the calculated acoustic scene parameters. For example, 810 may be performed by the UE 602 in FIG. 6, which may calculate a carrier-to-noise ratio based on the calculated acoustic scene parameters. 810 may also be performed by the component 198 in FIG. 1, 3, or 11.

At 812, the UE may select an operation mode from a set of operation modes of a PE based on the calculated acoustic scene parameters. For example, 812 may be performed by the UE 602 in FIG. 6, which may select an operation mode from a set of operation modes of a PE (e.g., deep urban, suburban, indoor, free field) based on the calculated acoustic scene parameters. 812 may also be performed by the component 198 in FIG. 1, 3, or 11.

At 814, the UE may calculate the position of the UE using the PE further based on the selected operation mode. For example, 814 may be performed by the UE 602 in FIG. 6, which may calculate the position of the UE 602 using the PE further based on the selected operation mode. For example, one operation mode may have a first time update model and another operation mode may have a different time update model. In another example, one operation mode may have a first noise uncertainty R model in a Kalman filter, and another operation mode may have a second noise uncertainty R model in a Kalman filter. 814 may also be performed by the component 198 in FIG. 1, 3, or 11.

At 816, the UE may receive a PRS from a network node. For example, 816 may be performed by the UE 602 in FIG. 6, which may receive a PRS from a network node. For example, the UE 602 may receive a PRS from the base station 605, or may receive a PRS from the base station 604 via the AP 606. 816 may also be performed by the component 198 in FIG. 1, 3, or 11.

At 818, the UE may measure the PRS. For example, 818 may be performed by the UE 602 in FIG. 6, which may measure the received PRS. 818 may also be performed by the component 198 in FIG. 1, 3, or 11.

At 820, the UE may calculate the position of the UE further based on the measured PRS. For example, 820 may be performed by the UE 602 in FIG. 6, which may calculate the position of the UE 602 further based on the measured PRS. The UE 602 may calculate its position based on the selected operation mode of the PE. 820 may also be performed by the component 198 in FIG. 1, 3, or 11.

At 822, the UE may perform a NLOS detection with a TRP of a network node in response to a number of echoes of the acoustic scene parameters associated with each of a set directions being less than or equal to a threshold level. For example, 822 may be performed by the UE 602 in FIG. 6, which may perform a NLOS detection with a TRP of the base station 604 in response to a number of echoes of the acoustic scene parameters associated with the direction associated with the AW 618 being less than or equal to a threshold level. A number of echoes lower than the threshold level may indicate a LOS direction, while a number of echoes above the threshold level may indicate a NLOS direction. 822 may also be performed by the component 198 in FIG. 1, 3, or 11.

At 824, the UE may communicate a positioning signal with the TRP based on the NLOS detection. For example, 824 may be performed by the UE 602 in FIG. 6, which may communicate a positioning signal with the TRP of the base station 604 based on the NLOS detection. The UE 602 may communicate a positioning signal with the base station 604 via the AP 606 based on determining that the object 638 reflects the AW 618 as the AW echo 622 in response to the UE 602 transmitting the AW 618 towards the base station 604. The UE 602 may communicate a positioning signal with the base station 605 based on determining that there is no object between the UE 602 and the base station 605. 824 may also be performed by the component 198 in FIG. 1, 3, or 11.

At 826, the UE may calculate the position of the UE further based on the communicated positioning signal. For example, 826 may be performed by the UE 602 in FIG. 6, which may calculate the position of the UE 602 further based on the communicated positioning signal. 826 may also be performed by the component 198 in FIG. 1, 3, or 11.

At 828, the UE may perform LEO positioning based on the calculated carrier-to-noise ratio. For example, 828 may be performed by the UE 602 in FIG. 6, which may perform LEO positioning with an LEO device, such as an LEO satellite or aircraft, based on the calculated carrier-to-noise ratio associated with the acoustic scene parameters. 828 may also be performed by the component 198 in FIG. 1, 3, or 11.

At 830, the UE may perform NTN communication with a second UE based on the calculated carrier-to-noise ratio. For example, 830 may be performed by the UE 602 in FIG. 6, which may perform NTN communication with a second UE, for example a UE in satellite communication with the UE 602, based on the calculated carrier-to-noise ratio associated with the acoustic scene parameters. 830 may also be performed by the component 198 in FIG. 1, 3, or 11.

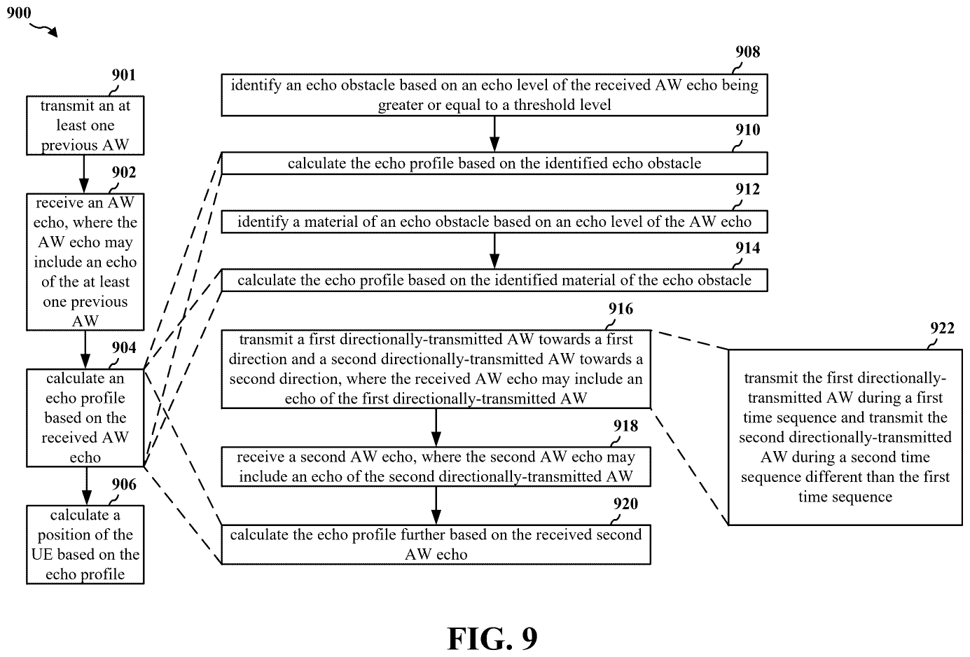

FIG. 9 is a flowchart 900 of a method of wireless communication. The method may be performed by a UE (e.g., the UE 104, the UE 350, the UE 404, the UE 502, the UE 602; the apparatus 1104). At 901, the UE may transmit an at least one previous AW. For example, 901 may be performed by the UE 602 in FIG. 6, which may transmit an AW 618 which may reflect off of the object 638 to be received as the AW echo 622. 901 may also be performed by the component 198 in FIG. 1, 3, or 11.

At 902, the UE may receive an AW echo. The AW echo may include an echo of at least one previous AW. For example, 902 may be performed by the UE 602 in FIG. 6, which may receive the AW echo 622, the AW echo 624, the AW echo 626, the AW echo 628, the AW echo 634, the AW echo 636, and/or the AW echo 646. The AW echoes may include an echo of a previous AW. For example, the AW echo 622 may be an echo of the AW 618. The AW echo 624 may be an echo of the AW 618. The AW echo 626 may be an echo of the AW 614. The AW echo 628 may be an echo of the AW 616. The AW echo 634 may be an echo of the AW 632. The AW echo 636 may be an echo of the AW 632. The AW echo 646 may be an echo of the AW 644. 902 may also be performed by the component 198 in FIG. 1, 3, or 11.

At 904, the UE may calculate an echo profile based on the received AW echo. For example, 904 may be performed by the UE 602 in FIG. 6, which may calculate an echo profile, such as a deep urban echo profile, based on the AW echo 622, the AW echo 624, the AW echo 626, the AW echo 628, the AW echo 634, the AW echo 636, and/or the AW echo 646. 904 may also be performed by the component 198 in FIG. 1, 3, or 11.

At 906, the UE may calculate a position of the UE based on the echo profile. For example, 906 may be performed by the UE 602 in FIG. 6, which may calculate a position of the UE 602 based on the echo profile by using an operation mode, such as a deep urban operation mode, to alter how the UE 602 performs positioning. 906 may also be performed by the component 198 in FIG. 1, 3, or 11.

At 908, the UE may identify an echo obstacle based on an echo level of the received AW echo being greater or equal to a threshold level. For example, 908 may be performed by the UE 602 in FIG. 6, which may identify the object 638 based on an echo level of the AW echo 622 received by the UE 602 being greater or equal to a threshold level. 908 may also be performed by the component 198 in FIG. 1, 3, or 11.

At 910, the UE may calculate the echo profile based on the identified echo obstacle. For example, 910 may be performed by the UE 602 in FIG. 6, which may calculate the echo profile based on the object 638. 910 may also be performed by the component 198 in FIG. 1, 3, or 11.

At 912, the UE may identify a material of an echo obstacle based on an echo level of the AW echo. For example, 912 may be performed by the UE 602 in FIG. 6, which may identify a material of the object 638 based on an echo level of the AW echo 622. 912 may also be performed by the component 198 in FIG. 1, 3, or 11.

At 914, the UE may calculate the echo profile based on the identified material of the echo obstacle. For example, 914 may be performed by the UE 602 in FIG. 6, which may calculate the echo profile based on the identified material of the object 638. For example, a plaster wall object may indicate an indoor environment, while a concrete wall object may indicate an outdoor environment. 914 may also be performed by the component 198 in FIG. 1, 3, or 11.

At 916, the UE may transmit a first directionally-transmitted AW towards a first direction and a second directionally-transmitted AW towards a second direction. The received AW echo may include an echo of the first directionally-transmitted AW. For example, 916 may be performed by the UE 602 in FIG. 6, which may transmit the AW 618 towards a first direction and the AW 614 towards a second direction. The AW echo 622 is an echo of the AW 618. 916 may also be performed by the component 198 in FIG. 1, 3, or 11.

At 918, the UE may receive a second AW echo. The second AW echo may include an echo of the second directionally-transmitted AW. For example, 918 may be performed by the UE 602 in FIG. 6, which may receive the AW echo 626. The AW echo 626 is an echo of the AW 614. 918 may also be performed by the component 198 in FIG. 1, 3, or 11.

At 920, the UE may calculate the echo profile further based on the received second AW echo. For example, 920 may be performed by the UE 602 in FIG. 6, which may calculate the echo profile further based on the AW echo 626. 920 may also be performed by the component 198 in FIG. 1, 3, or 11.

At 922, the UE may transmit the first directionally-transmitted AW during a first time sequence and transmit the second directionally-transmitted AW during a second time sequence different than the first time sequence. For example, 922 may be performed by the UE 602 in FIG. 6, which may transmit the AW 618 during a first time period and transmit the AW 614 during a second time period different than the first time period. 922 may also be performed by the component 198 in FIG. 1, 3, or 11.

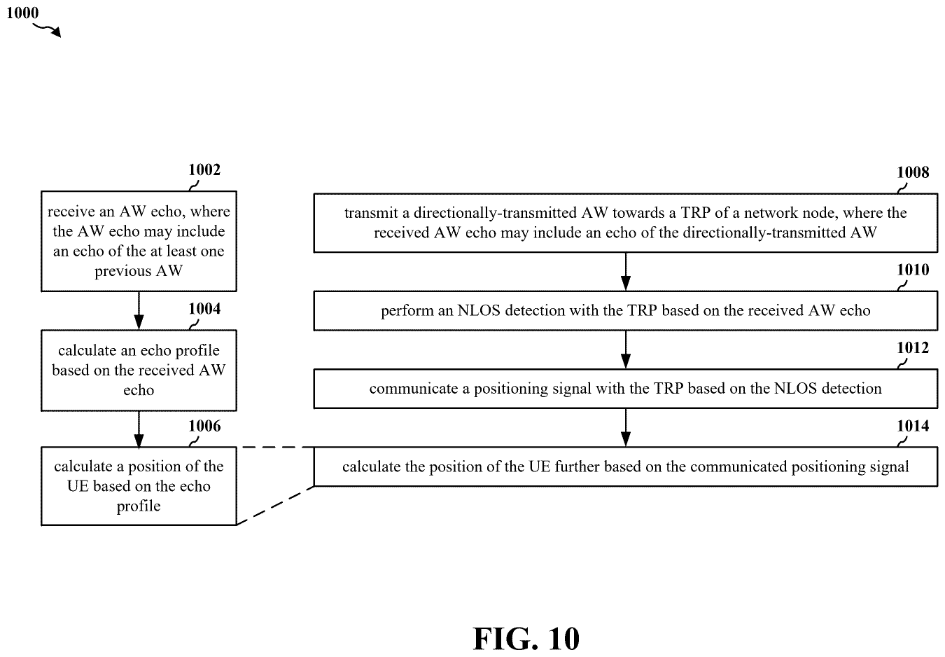

FIG. 10 is a flowchart 1000 of a method of wireless communication. The method may be performed by a UE (e.g., the UE 104, the UE 350, the UE 404, the UE 502, the UE 602; the apparatus 1104). At 1002, the UE may receive an AW echo. The AW echo may include an echo of at least one previous AW. For example, 1002 may be performed by the UE 602 in FIG. 6, which may receive the AW echo 622, the AW echo 624, the AW echo 626, the AW echo 628, the AW echo 634, the AW echo 636, and/or the AW echo 646. The AW echoes may include an echo of a previous AW. For example, the AW echo 622 may be an echo of the AW 618. The AW echo 624 may be an echo of the AW 618. The AW echo 626 may be an echo of the AW 614. The AW echo 628 may be an echo of the AW 616. The AW echo 634 may be an echo of the AW 632. The AW echo 636 may be an echo of the AW 632. The AW echo 646 may be an echo of the AW 644. 1002 may also be performed by the component 198 in FIG. 1, 3, or 11.

At 1004, the UE may calculate an echo profile based on the received AW echo. For example, 1004 may be performed by the UE 602 in FIG. 6, which may calculate an echo profile, such as a deep urban echo profile, based on the AW echo 622, the AW echo 624, the AW echo 626, the AW echo 628, the AW echo 634, the AW echo 636, and/or the AW echo 646. 1004 may also be performed by the component 198 in FIG. 1, 3, or 11.

At 1006, the UE may calculate a position of the UE based on the echo profile. For example, 1006 may be performed by the UE 602 in FIG. 6, which may calculate a position of the UE 602 based on the echo profile by using an operation mode, such as a deep urban operation mode, to alter how the UE 602 performs positioning. 1006 may also be performed by the component 198 in FIG. 1, 3, or 11.

At 1008, the UE may transmit a directionally-transmitted AW towards a TRP of a network node. The received AW echo may include an echo of the directionally-transmitted AW. For example, 1008 may be performed by the UE 602 in FIG. 6, which may transmit the AW 618 towards the base station 604 or the AW 616 towards the base station 605. The AW echo 622 is an echo of the AW 618. The AW echo 628 is an echo of the AW 616. 1008 may also be performed by the component 198 in FIG. 1, 3, or 11.

At 1010, the UE may perform an NLOS detection with the TRP based on the received AW echo. For example, 1010 may be performed by the UE 602 in FIG. 6, which may perform an NLOS detection with the base station 604 based on the AW echo 622. The UE 602 may perform an NLOS detection with the base station 605 based on the AW echo 628. 1010 may also be performed by the component 198 in FIG. 1, 3, or 11.

At 1012, the UE may communicate a positioning signal with the TRP based on the NLOS detection. For example, 1012 may be performed by the UE 602 in FIG. 6, which may communicate a positioning signal with the base station 604 via the AP 606 based on the NLOS detection determining that the object 638 blocks a LOS path between the base station 604 and the UE 602. The UE 602 may communicate a positioning signal with the base station 605 via a LOS path based on the NLOS detection determining that no object blocks a LOS path between the base station 605 and the UE 602. 1012 may also be performed by the component 198 in FIG. 1, 3, or 11.

At 1014, the UE may calculate the position of the UE further based on the communicated positioning signal. For example, 1014 may be performed by the UE 602 in FIG. 6, which may calculate the position of the UE 602 further based on the communicated positioning signal. 1014 may also be performed by the component 198 in FIG. 1, 3, or 11.

FIG. 11 is a diagram 1100 illustrating an example of a hardware implementation for an apparatus 1104. The apparatus 1104 may be a UE, a component of a UE, or may implement UE functionality. In some aspects, the apparatus 804 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to receive an AW echo. The AW echo may include an echo of at least one previous AW. The component 198 may be configured to calculate an echo profile based on the received AW echo. The component 198 may be configured to calculate an echo profile based on the received AW echo. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for receiving an AW echo. The AW echo may include an echo of at least one previous AW. The apparatus 1104 may include means for calculating an echo profile based on the received AW echo. The apparatus 1104 may include means for calculating a position of the UE based on the echo profile. The apparatus 1104 may include means for receiving the AW echo by receiving the AW echo via a set of microphones. The apparatus 1104 may include means for calculating acoustic scene parameters based on at least one of the echo profile or environmental sounds. The apparatus 1104 may include means for calculating the position of the UE by calculating the position of the UE further based on the calculated acoustic scene parameters. The acoustic scene parameters may include at least one of a number of echoes, an echo level associated with each of the number of echoes, a number of urban noises, a number of room noises, a size of an echo obstacle, a location of an echo obstacle, or a reverberation decay. The apparatus 1104 may include means for performing a NLOS detection with a TRP of a network node in response to the number of echoes associated with each of a set directions being less than or equal to a threshold level. The apparatus 1104 may include means for communicating a positioning signal with the TRP based on the NLOS detection. The apparatus 1104 may include means for calculating the position of the UE by calculating the position of the UE further based on the communicated positioning signal. The apparatus 1104 may include means for selecting an operation mode from a set of operation modes of a PE based on the calculated acoustic scene parameters. The apparatus 1104 may include means for calculating the position of the UE by calculating the position of the UE using the PE further based on the selected operation mode. The set of operation modes may include a free field operation mode, a deep urban operation mode, a suburban operation mode, or an indoor operation mode. A first operation mode of the set of operation modes may include a first time update model. A second operation mode of the set of operation modes may include a second time update model. The first time update model and the second time update model may be different. The selected operation mode may include the first operation mode or the second operation mode. A first operation mode of the set of operation modes may include a first noise uncertainty model. A second operation mode of the set of operation modes may include a second noise uncertainty model. The first noise uncertainty model and the second noise uncertainty model may be different. The selected operation mode may include the first operation mode or the second operation mode. The apparatus 1104 may include means for receiving a PRS from a network node. The apparatus 1104 may include means for measuring the PRS. The apparatus 1104 may include means for calculating the position of the UE based on the operation mode of the PE by calculating the position of the UE further based on the measured PRS. The apparatus 1104 may include means for calculating a carrier-to-noise ratio based on the calculated acoustic scene parameters. The apparatus 1104 may include means for performing LEO positioning based on the calculated carrier-to-noise ratio. The apparatus 1104 may include means for performing NTN communication with a second UE based on the calculated carrier-to-noise ratio. The apparatus 1104 may include means for transmitting the at least one previous AW prior to receiving the AW. The apparatus 1104 may include means for identifying an echo obstacle based on an echo level of the received AW echo being greater or equal to a threshold level. The apparatus 1104 may include means for calculating the echo profile based on the received AW echo by calculating the echo profile based on the identified echo obstacle. The apparatus 1104 may include means for identifying a material of an echo obstacle based on an echo level of the AW echo. The apparatus 1104 may include means for calculating the echo profile based on the received AW echo by calculating the echo profile based on the identified material of the echo obstacle. The apparatus 1104 may include means for transmitting a directionally-transmitted AW towards a TRP of a network node. The received AW echo may include an echo of the directionally-transmitted AW. The apparatus 1104 may include means for performing an NLOS detection with a TRP of a network node based on the received AW echo. The apparatus 1104 may include means for communicating a positioning signal with the TRP based on the NLOS detection. The apparatus 1104 may include means for calculating the position of the UE by calculating the position of the UE further based on the communicated positioning signal. The apparatus 1104 may include means for transmitting a first directionally-transmitted AW towards a first direction and a second directionally-transmitted AW towards a second direction. The received AW echo may include an echo of the first directionally-transmitted AW. The apparatus 1104 may include means for receiving a second AW echo. The second AW echo may include an echo of the second directionally-transmitted AW. The apparatus 1104 may include means for calculating the echo profile further based on the second AW echo. The apparatus 1104 may include means for transmitting the first directionally-transmitted AW towards the first direction and the second directionally-transmitted AW towards the second direction by transmitting the first directionally-transmitted AW during a first time sequence and transmitting the second directionally-transmitted AW during a second time sequence different than the first time sequence. A first portion of a first signature of the AW echo may be the same as a second portion of a second signature of the at least one previous AW. The AW echo may include an echo of at least one previous AW. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive the data, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, where the method may include receiving an AW echo. The AW echo may include an echo of at least one previous AW. The method may include calculating an echo profile based on the received AW echo. The method may include calculating a position of the UE based on the echo profile.
Aspect 2 is the method of aspect 1, where receiving the AW echo may include receiving the AW echo via a set of microphones.
Aspect 3 is the method of either of aspects 1 or 2, where the method may include calculating acoustic scene parameters based on at least one of the echo profile or environmental sounds. Calculating the position of the UE may include calculating the position of the UE further based on the calculated acoustic scene parameters.
Aspect 4 is the method of aspect 3, where the acoustic scene parameters may include at least one of a number of echoes, an echo level associated with each of the number of echoes, a number of urban noises, a number of room noises, a size of an echo obstacle, a location of an echo obstacle, or a reverberation decay.
Aspect 5 is the method of aspect 4, where the method may include performing a NLOS detection with a TRP of a network node in response to the number of echoes associated with each of a set directions being less than or equal to a threshold level. The method may include communicating a positioning signal with the TRP based on the NLOS detection. Calculating the position of the UE may include calculating the position of the UE further based on the communicated positioning signal.
Aspect 6 is the method of any of aspects 3 to 5, where the method may include selecting an operation mode from a set of operation modes of a PE based on the calculated acoustic scene parameters. Calculating the position of the UE may include calculating the position of the UE using the PE further based on the selected operation mode.
Aspect 7 is the method of aspect 6, where the set of operation modes may include a free field operation mode, a deep urban operation mode, a suburban operation mode, or an indoor operation mode.
Aspect 8 is the method of either of aspects 6 or 7, where a first operation mode of the set of operation modes may include a first time update model. A second operation mode of the set of operation modes may include a second time update model. The first time update model and the second time update model may be different. The selected operation mode may include the first operation mode or the second operation mode.
Aspect 9 is the method of any of aspects 6 to 8, where a first operation mode of the set of operation modes may include a first noise uncertainty model. A second operation mode of the set of operation modes may include a second noise uncertainty model. The first noise uncertainty model and the second noise uncertainty model may be different. The selected operation mode may include the first operation mode or the second operation mode.
Aspect 10 is the method of any of aspects 6 to 9, where the method may include receiving a PRS from a network node. The method may include measuring the PRS. Calculating the position of the UE based on the operation mode of the PE may include calculating the position of the UE further based on the measured PRS.
Aspect 11 is the method of any of aspects 3 to 10, where the method may include calculating a carrier-to-noise ratio based on the calculated acoustic scene parameters.
Aspect 12 is the method of aspect 11, where the method may include performing LEO positioning based on the calculated carrier-to-noise ratio.
Aspect 13 is the method of either of aspects 11 or 12, where the method may include performing NTN communication with a second UE based on the calculated carrier-to-noise ratio.
Aspect 14 is the method of any of aspects 1 to 13, where the method may include transmitting the at least one previous AW prior to receiving the AW.
Aspect 15 is the method of any of aspects 1 to 14, where the method may include identifying an echo obstacle based on an echo level of the received AW echo being greater or equal to a threshold level. Calculating the echo profile based on the received AW echo may include calculating the echo profile based on the identified echo obstacle.
Aspect 16 is the method of any of aspects 1 to 15, where the method may include identifying a material of an echo obstacle based on an echo level of the AW echo. Calculating the echo profile based on the received AW echo may include calculating the echo profile based on the identified material of the echo obstacle.
Aspect 17 is the method of any of aspects 1 to 16, where the method may include transmitting a directionally-transmitted AW towards a TRP of a network node. The received AW echo may include an echo of the directionally-transmitted AW. The method may include performing an NLOS detection with a TRP of a network node based on the received AW echo. The method may include communicating a positioning signal with the TRP based on the NLOS detection. Calculating the position of the UE may include calculating the position of the UE further based on the communicated positioning signal.
Aspect 18 is the method of any of aspects 1 to 17, where the method may include transmitting a first directionally-transmitted AW towards a first direction and a second directionally-transmitted AW towards a second direction. The received AW echo may include an echo of the first directionally-transmitted AW. The method may include receiving a second AW echo. The second AW echo may include an echo of the second directionally-transmitted AW. Calculating the echo profile may be further based on the second AW echo.
Aspect 19 is the method of aspect 18, where transmitting the first directionally-transmitted AW towards the first direction and the second directionally-transmitted AW towards the second direction may include transmitting the first directionally-transmitted AW during a first time sequence and transmitting the second directionally-transmitted AW during a second time sequence different than the first time sequence.
Aspect 20 is the method of any of aspects 1 to 19, where a first portion of a first signature of the AW echo may be the same as a second portion of a second signature of the at least one previous AW.
Aspect 21 is an apparatus for wireless communication, including: a memory; and at least one processor coupled to the memory and, based at least in part on information stored in the memory, the at least one processor, individually or in any combination, is configured to implement any of aspects 1 to 20.
Aspect 22 is the apparatus of aspect 21, further including at least one of an antenna or a transceiver coupled to the at least one processor configured to receive or transmit in association with any of the aspects 1 to 20.
Aspect 23 is an apparatus for wireless communication including means for implementing any of aspects 1 to 20.
Aspect 24 is a computer-readable medium (e.g., a non-transitory computer-readable medium) storing computer executable code, where the code when executed by a processor causes at least one processor, individually or in any combination, to implement any of aspects 1 to 20.

1. An apparatus for wireless communication at a user equipment (UE), comprising:
memory; and
at least one processor coupled to the memory and, based at least in part on information stored in the memory, the at least one processor, individually or in any combination, is configured to:
receive an audio wave (AW) echo, wherein the AW echo comprises an echo of at least one previous AW;
determine an echo profile based on the received AW echo; and
determine a position of the UE based on the echo profile.

2. The apparatus of claim 1, wherein, to receive the AW echo, the at least one processor, individually or in any combination, is configured to:
receive the AW echo via a set of microphones.

3. The apparatus of claim 1, wherein the at least one processor, individually or in any combination, is further configured to:
determine acoustic scene parameters based on at least one of the echo profile or environmental sounds, wherein, to determine the position of the UE, the at least one processor is configured to:
determine the position of the UE further based on the determined acoustic scene parameters.

4. The apparatus of claim 3, wherein the acoustic scene parameters comprise at least one of a number of echoes, an echo level associated with each of the number of echoes, a number of urban noises, a number of room noises, a size of an echo obstacle, a location of the echo obstacle, or a reverberation decay.

5. The apparatus of claim 4, wherein the at least one processor, individually or in any combination, is further configured to:
perform a non-line-of-sight (NLOS) detection with a transmission reception point (TRP) of a network node in response to the number of echoes associated with each of a set directions being less than or equal to a threshold level; and
communicate a positioning signal with the TRP based on the NLOS detection, wherein, to determine the position of the UE, the at least one processor is configured to;
determine the position of the UE further based on the communicated positioning signal.

6. The apparatus of claim 3, wherein the at least one processor, individually or in any combination, is further configured to:
select an operation mode from a set of operation modes of a positioning engine (PE) based on the determined acoustic scene parameters, wherein, to determine the position of the UE, the at least one processor is configured to:
determine the position of the UE using the PE further based on the selected operation mode.

7. The apparatus of claim 6, wherein the set of operation modes comprises a free field operation mode, a deep urban operation mode, a suburban operation mode, or an indoor operation mode.

8. The apparatus of claim 6, wherein a first operation mode of the set of operation modes comprises a first time update model, wherein a second operation mode of the set of operation modes comprises a second time update model, wherein the first time update model and the second time update model are different, wherein the selected operation mode comprises the first operation mode or the second operation mode.

9. The apparatus of claim 6, wherein a first operation mode of the set of operation modes comprises a first noise uncertainty model, wherein a second operation mode of the set of operation modes comprises a second noise uncertainty model, wherein the first noise uncertainty model and the second noise uncertainty model are different, wherein the selected operation mode comprises the first operation mode or the second operation mode.

10. The apparatus of claim 6, wherein the at least one processor, individually or in any combination, is further configured to:
receive a positioning reference signal (PRS) from a network node; and
measure the PRS, wherein, to determine the position of the UE based on the operation mode of the PE, the at least one processor is configured to:
determine the position of the UE further based on the measured PRS.

11. The apparatus of claim 10, further comprising a transceiver coupled to the at least one processor, wherein, to receive the PRS from the network node, the at least one processor is configured to;
receive, via the transceiver, the PRS from the network node.

12. The apparatus of claim 3, wherein the at least one processor, individually or in any combination, is further configured to:
determine a carrier-to-noise ratio based on the determined acoustic scene parameters.

13. The apparatus of claim 12, wherein the at least one processor, individually or in any combination, is further configured to:
perform low-earth orbit (LEO) positioning based on the determined carrier-to-noise ratio.

14. The apparatus of claim 12, wherein the at least one processor, individually or in any combination, is further configured to:
perform non-terrestrial network (NTN) communication with a second UE based on the determined carrier-to-noise ratio.

15. The apparatus of claim 1, wherein the at least one processor is further configured to:
transmit the at least one previous AW prior before receiving the AW echo.

16. The apparatus of claim 1, wherein the at least one processor, individually or in any combination, is further configured to:
identify an echo obstacle based on an echo level of the received AW echo being greater or equal to a threshold level, wherein, to calculate the echo profile based on the received AW echo, the at least one processor is configured to calculate the echo profile based on the identified echo obstacle;
identify a material of the echo obstacle based on the echo level of the AW echo, wherein, to calculate the echo profile based on the received AW echo, the at least one processor is configured to calculate the echo profile based on the identified material of the echo obstacle; or
transmit a first directionally-transmitted AW towards a first direction and a second directionally-transmitted AW towards a second direction, wherein the received AW echo comprises a second echo of the first directionally-transmitted AW, and receive a second AW echo, wherein the second AW echo comprises a third echo of the second directionally-transmitted AW, wherein, to calculate the echo profile, the at least one processor is configured to calculate the echo profile further based on the received second AW echo.

17-18. (canceled)

19. The apparatus of claim 16, wherein, to transmit the first directionally-transmitted AW towards the first direction and the second directionally-transmitted AW towards the second direction, the at least one processor is configured to;
transmit the first directionally-transmitted AW during a first time sequence and is configured to transmit the second directionally-transmitted AW during a second time sequence different than the first time sequence.

20. The apparatus of claim 1, wherein the at least one processor, individually or in any combination, is further configured to:
transmit a directionally-transmitted AW towards a transmission reception point (TRP) of a network node, wherein the received AW echo comprises a second echo of the directionally-transmitted AW;
perform a non-line-of-sight (NLOS) detection with the TRP based on the received AW echo; and
communicate a positioning signal with the TRP based on the NLOS detection, wherein, to determine the position of the UE, the at least one processor is further configured to:
determine the position of the UE further based on the communicated positioning signal.

21. The apparatus of claim 1, wherein a first portion of a first signature of the AW echo is a same signature as a second portion of a second signature of the at least one previous AW.

22. A method of wireless communication at a user equipment (UE), comprising:
receiving an audio wave (AW) echo, wherein the AW echo comprises an echo of at least one previous AW;
determining an echo profile based on the received AW echo; and
determining a position of the UE based on the echo profile.

23-30. (canceled)
